(19) United States
(12) Patent Application Publication
(10) Pub. No.: US 2019/0134636 A1
(43) Pub. Date: May 9, 2019

(54) METHOD AND DEVICE FOR MICROARRAYS ANALYSIS

(71) Applicant: PARALLEX BIOASSAYS INC., ST-BASILE-LE-GRAND (CA)

(72) Inventor: SÉBASTIEN BERGERON, ST-BASILE-LE-GRAND (CA)

(21) Appl. No.: 16/098,536

(22) PCT Filed: May 1, 2017
(86) PCT No.: PCT/CA2017/050524

§ 371 Date: Nov. 2, 2018

Related U.S. Application Data
(60) Provisional application No. 62/333,328, filed on May 9, 2016.

(51) Int. Cl. B01L 3/00

(52) U.S. Cl. CPC B01L 3/5635; B01L 3/5088; B01L 2300/0636; B01L 2300/0822; B01L 2200/025

(57) ABSTRACT

A microarray-to-microarray transfer device and method, the device comprising a first shell and a second shell, the inner surface of the first shell comprising reference position pins, first movable pins and second movable pins, the first and second movable pins being movable from a resting position allowing insertion of a bottom slide to a working position, the first movable pins, in a working position thereof, pushing the bottom slide against the reference pins and maintaining a desired distance between the bottom slide and a top slide until the device is closed, and the second movable pins, in a working position thereof, maintaining the bottom slide and the top slide both aligned against the reference position pins.

### FIELD OF THE INVENTION

The present invention relates to microarrays analysis. More specifically, the present invention is concerned with a method and a device for microarrays analysis.

### BACKGROUND OF THE INVENTION

Multiplexed sandwich immunoassay is a powerful technique to measure multiple protein concentrations simultaneously. While capture antibodies are individually immobilized on a surface, detection antibodies are commonly mixed and applied to a microarray as a so-called “detection soup”. A number of non-specific interactions occur in this detection soup, which translate into false positive signals or background noise, which increase exponentially with the number of target to be analysed on the microarray.

A method to deliver the detection antibodies using a microarray-to-microarray transfer was recently proposed, in which, as illustrated for example in FIG. 1, the detection soup is replaced by an array of pre-spotted detection antibodies. Using a snap device for a precise alignment and transfer, a capture and a detection arrays are brought together in order to precisely deliver the detection antibodies to their cognate spots (see step C in FIG. 1). As a result, a cross-reaction-free multiplexed sandwich immunoassay is obtained, comprising an assembly of parallelized assays, physically isolated from one another. Each shell of the snap device used to bring the capture and the detection array together comprises one slide. The relative position of the slides when brought together depends on the relative position of the shells, which may vary from one assembly to another due to fabrication tolerance. Also, maintaining the slides on the shells may prove challenging as pins pushing on a first slide edge to maintain the first slide in its shell may abut the top of the second slide if the first and second slides are not perfectly aligned for example, with interference between the slides and the pins. Slight variations in the slide dimensions, as commonly observed, may also result in interference between a pin and its opposite slide.

There is still a need in the art for a method and a device for microarrays analysis.

### SUMMARY OF THE INVENTION

More specifically, in accordance with the present invention, there is provided a microarray-to-microarray transfer device, comprising a first shell having an inner surface configured to receive a bottom slide and a top slide; and a second shell configured to be assembled on top of the first shell with an inner surface thereof facing the inner surface of the first shell in a closed position of the device; wherein the inner surface of the first shell comprises reference position pins, first movable pins and second movable pins, the first and second movable pins being movable from a resting position allowing insertion of the bottom slide to a working position, the first movable pins, in a working position thereof, pushing the bottom slide against the reference pins and maintain a desired distance between the bottom slide and the top slide until the device is closed, and the second movable pins, in a working position thereof, maintaining the bottom slide and the top slide both aligned against the reference position pins.

There is further provided a method of microarray-to-microarray transfer, comprising providing a first shell comprising position pins and first and second movable pins on an inner surface thereof; setting the first and second movable pins in a rest position and inserting a first slide on the inner surface of the first shell; setting the first movable pins in a working position, thereby aligning the first slide against the position pins; depositing a second slide on top of the first movable pins; setting the second movable pins in a working position thereof, thereby aligning the first and second slides against the position pins as common reference position pins; and assembling a second shell on top of the first shell.

There is further provided a method of microarray-to-microarray transfer, comprising inserting a first slide on an inner surface of a first shell and aligning the first slide against reference pins of the inner surface of the first shell using first movable pins of the inner surface of the first shell; inserting a second slide on a top tips of the first movable pins; aligning the first and second slides against the reference pins using second movable pins of the inner surface of the first shell; and assembling a second shell on top of the first shell.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a flowchart of a method of multiplexed sandwich immunoassay as known in the art;

FIG. 2 is an exploded view of a device according to an embodiment of an aspect of the present invention;

FIG. 3 is a perspective view of a top shell of the device of FIG. 2;

FIG. 4 is a perspective view of a base shell of the device of FIG. 2;

FIG. 5 shows details of the shell of FIG. 4;

FIG. 6 shows details of the shell of FIG. 4;

FIG. 7 shows details of the shell of FIG. 4;

FIG. 8 is a section of a plunger pogopin according to an embodiment of an aspect of the present invention;

FIG. 9 is a section of a plunger according to an embodiment of an aspect of the present invention;

FIG. 10A shows a clamp according to an embodiment of an aspect of the present invention;

FIG. 10B is a side view of the clamp of FIG. 10A;

FIG. 10C is a tab used with the clamp of FIG. 10A;

FIG. 10D shows the device inserted within the clamp of FIGS. 10A-10B with the tab of FIG. 10C;

FIG. 11a is a top plan view of a slide according to an embodiment of an aspect of the present invention;

FIG. 11B is a side view of a slide according to an embodiment of an aspect of the present invention;

FIG. 12 shows a deck according to an embodiment of an aspect of the present invention;

FIG. 13 shows mating pins used as reference position pins for both slides according to an embodiment of an aspect of the present invention; and

FIG. 14 shows pins used as reference position pins for both slides according to an embodiment of an aspect of the present invention.

### DESCRIPTION OF ILLUSTRATIVE EMBODIMENTS

The present invention is illustrated in further details by the following non-limiting examples.

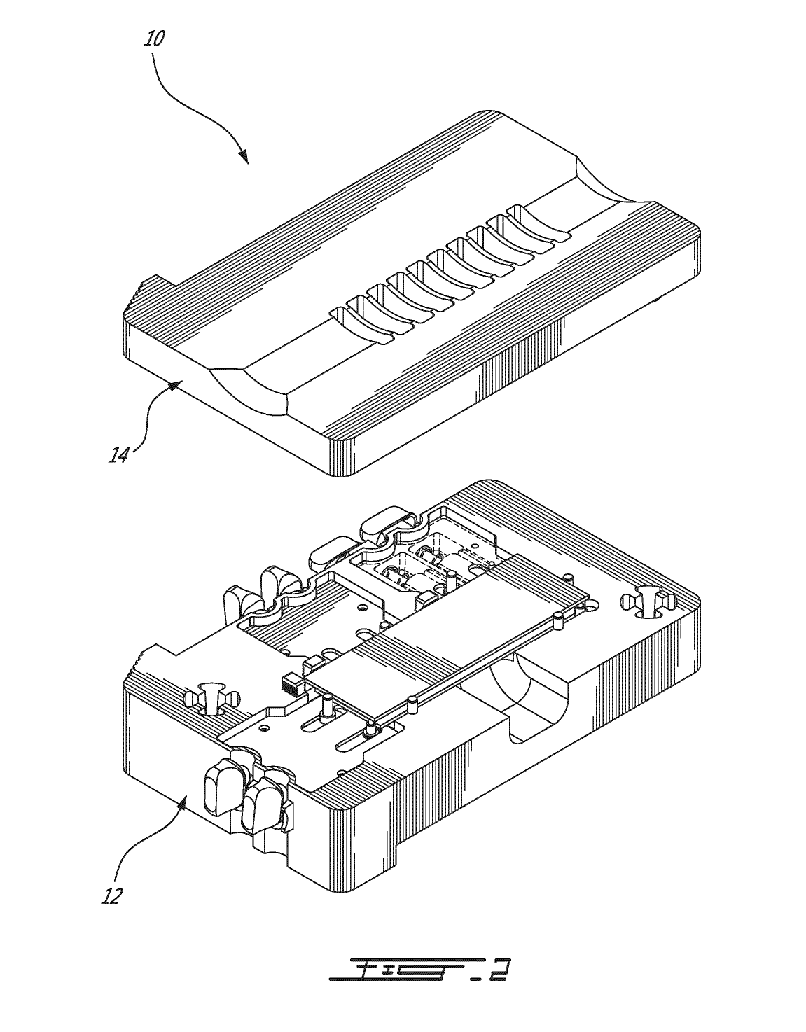

A microarray-to-microarray transfer device 10 according to an embodiment of an aspect of the present invention will be described in relation to FIGS. 2-9.

As illustrated in FIG. 2, the device 10 comprises a base shell 12 and a top shell 14. Each shell may be CNC molded in a thermoplastic polymer, such as acrylonitrile butadiene styrene (ABS) for example.

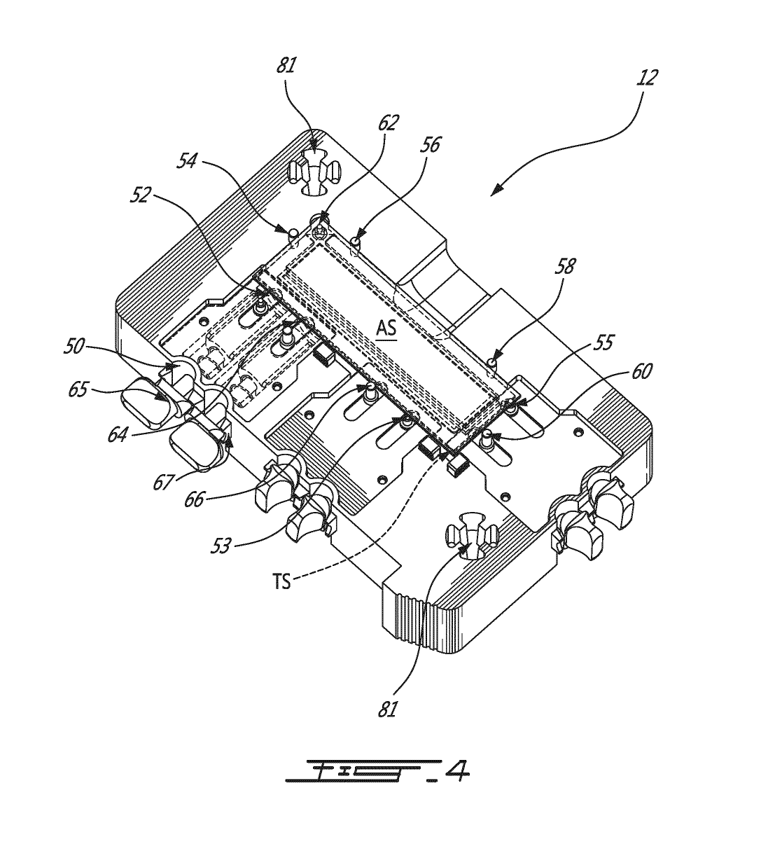

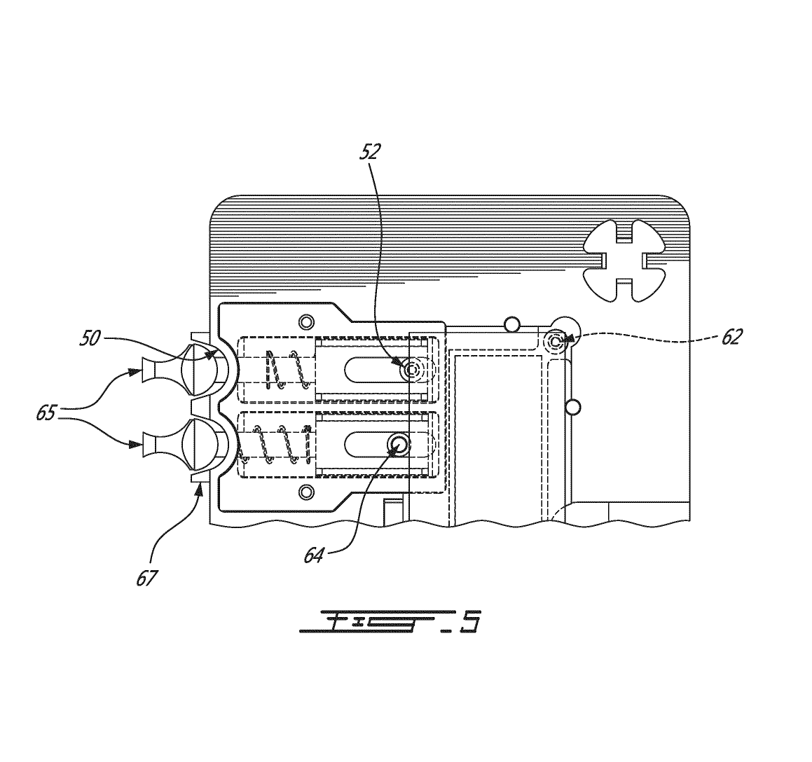

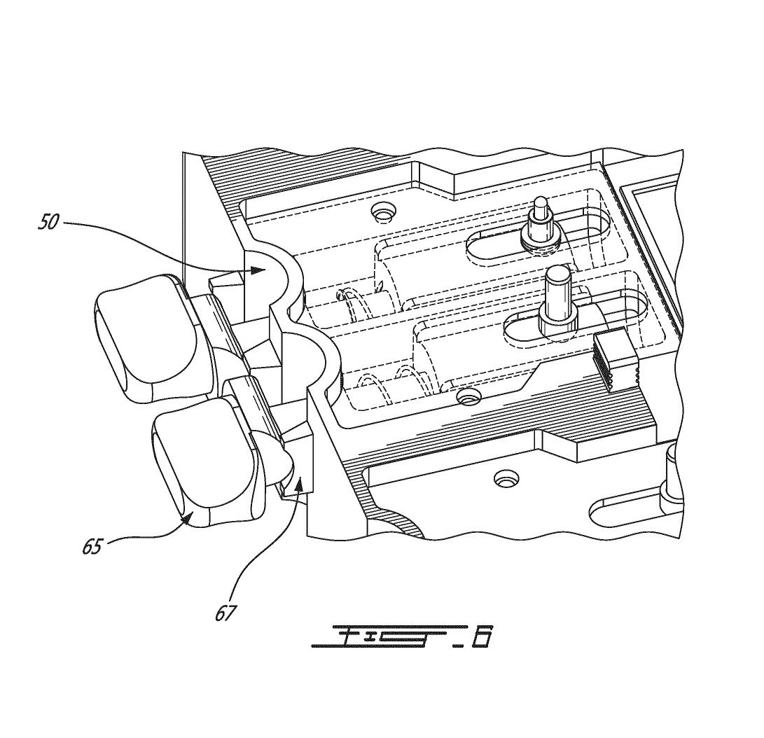

The inner surface of the shell 12, shown in FIGS. 4-7, comprises fixed reference position pins 54, 56, 58 and movable pins 60, 64, 66 and 52, 53, 55. Each movable pin 60, 64, 66 and 52, 53, 55 is driven by a rod and spring unit for example (best seen in FIGS. 4, 5, 7 and 8), which can be set in a working position (see FIG. 5) by positioning a head 65 thereof within a notch 50 in the lateral side of the shell 12 for example, and in a rest position (see FIG. 6) by resting the head 65 thereof on side walls 67 protruding from the lateral side of the shell 12 for example.

The inner surface of the base shell 12 is intended to receive slides, i.e. a bottom slide TS (for Transfer Slide) and a top slide AS (for Assay Slide). The bottom slide TS is disposed on a foam (not shown) on the top surface of the shell 12. The fixed reference position pins 54, 56, 58 are positioned so as to form a right angle so as to receive two adjacent edges of the slides; the movable pins 60, 64, 66 and 52, 53, 55 are positioned so as to form a diagonally opposed right angle as shown in FIG. 4.

In the working position, the movable pins 60, 64, 66 and 52, 53, 55 maintain the bottom slide TS and the top slide AS perfectly aligned against the reference position pins 54, 56, 58.

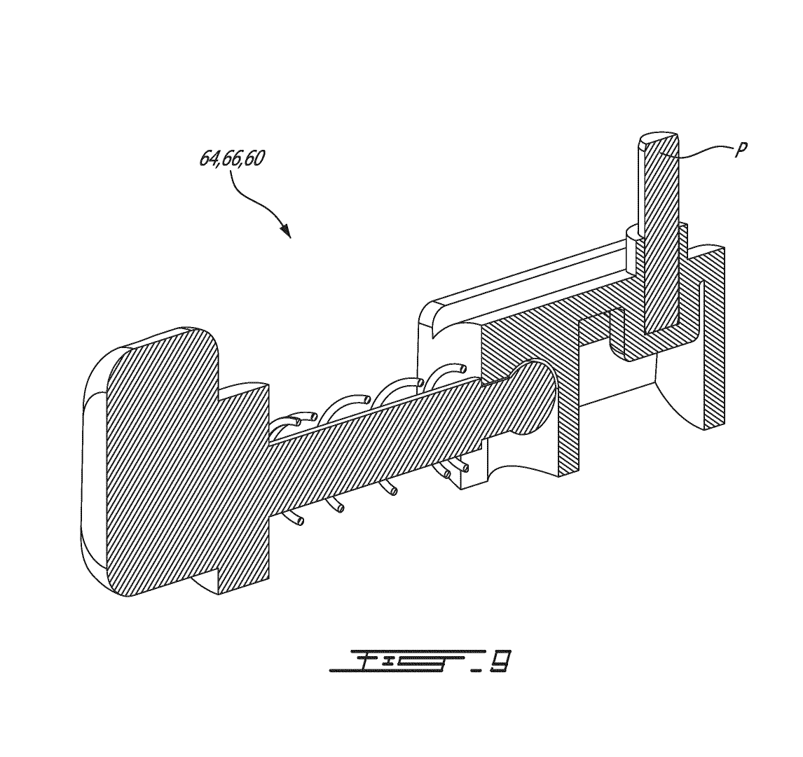

The movable pins 60, 64, 66 (best seen in FIG. 9) are movable so that they come into abutment against the lateral edge of the top slide AS in the working position (see FIG. 5).

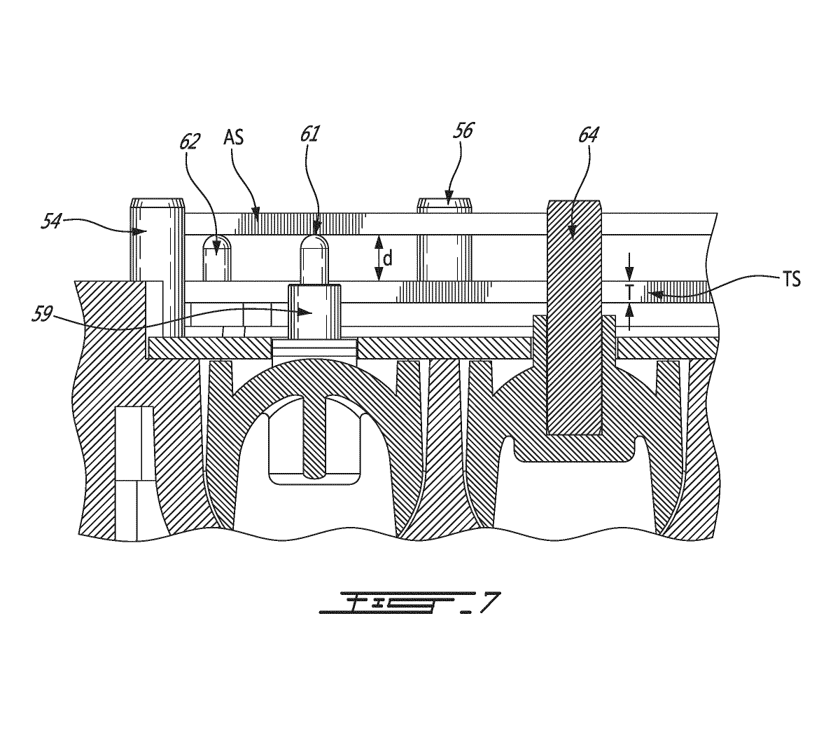

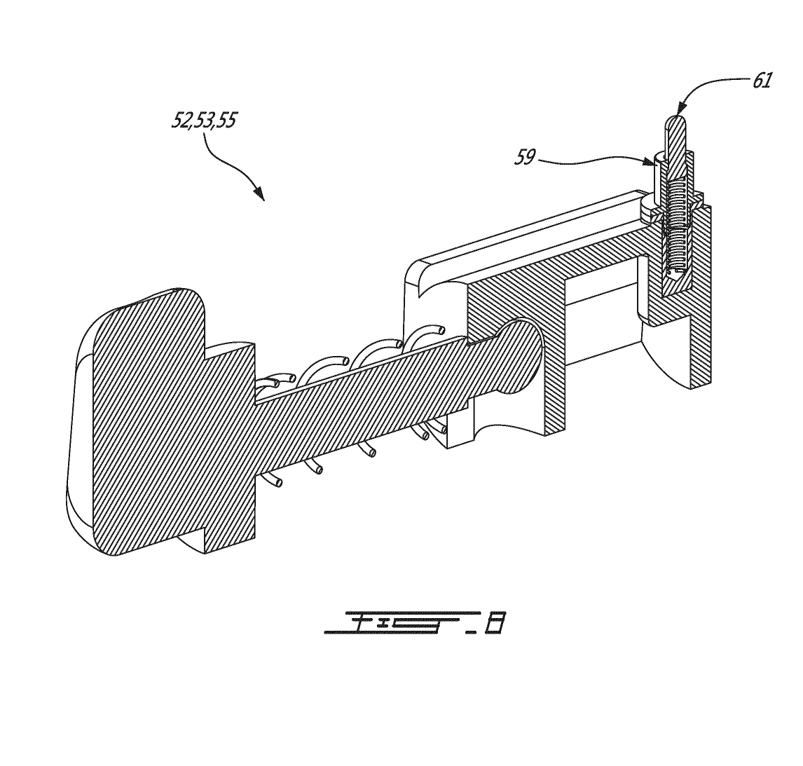

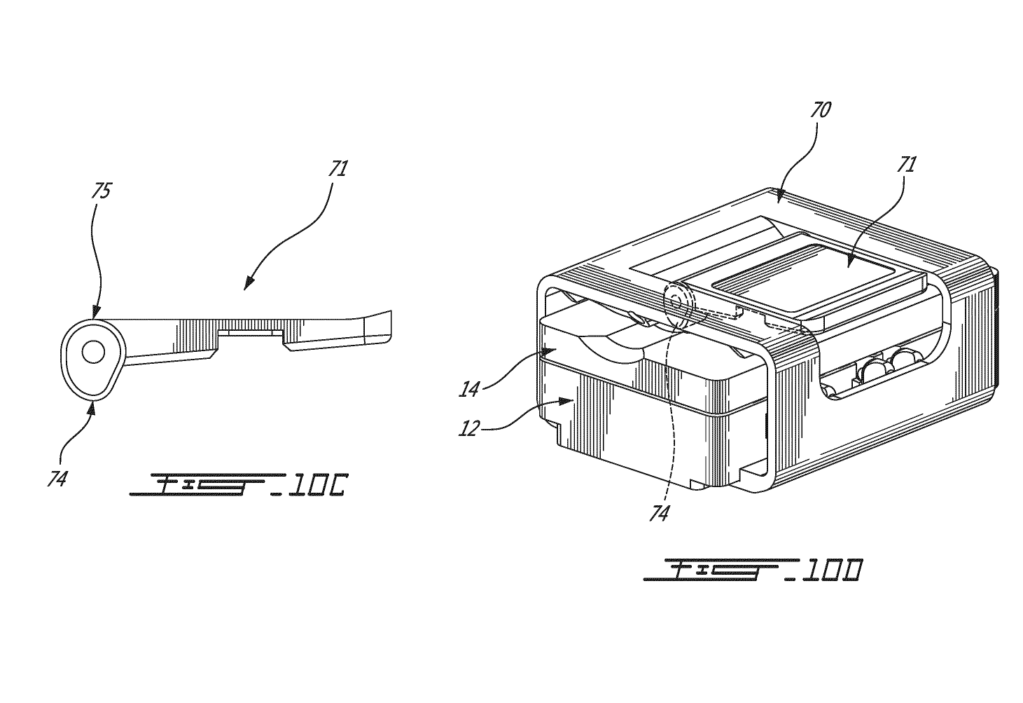

The movable pins 52, 53, 55, shown as pogo pin plungers (see FIG. 8), each comprises a body 59 that pushes the bottom slide TS against the reference pins 54, 56, 58 and a spring-loaded tip section 61 that maintains a desired distance d between the bottom slide TS and the top slide (see FIG. 7) until the device 10 is closed and a pressure is applied to bring the two slides together as described hereinbelow. The bottom slide TS may have indentations on its circumference (not shown), so that the pogo pins 52, 53, 55 can be moved in such a way that, when their body 59 comes into abutment against the lateral edge of the bottom slide TS within these indentations, their tip 61 reaches up in contact with the under surface of the top slide AS, in the working position. Such indentations may further eliminates the risk that the bottom slide TS prevents the movable pins 64, 66, 60 from firmly abutting against the top slide AS. Alternatively, the bottom slide can be of a size, i.e. a width and a length, smaller than the top slide, and/or provided with a clipped corner 110 as described hereinbelow in relation to FIG. 11A for example.

The pogo pin tips 59/61 of the movable pins 52, 53, 55 illustrated herein could be replaced by compressible elements, i.e. in a material such as foam, silicon and rubber, achieving the functions described hereinabove i.e. adapted to push the bottom slide against the reference pins while maintaining a desired distance between the bottom slide and the top slide until the device is closed and a pressure is applied to bring the two slides together:

A fixed pogo pin 62 may be positioned opposite the movable pogo pin 52, to support the corresponding corner of the top slide and maintain the desired distance d between the bottom slide TS and top slide AS, together with the pogo pins 52, 53, 55. As will be described further below in relation to FIG. 11A, the bottom slide may have a clipped corner at this position so as to allow positioning of this fixed pogo pin 62 to reach the under surface of the top slide AS.

Thus a number of movable pins 52, 53, 55 and 64, 66, 60 are shown. In the working position thereof, they abut against the slides as described hereinabove (see FIGS. 5 and 7 for example). In the rest position, i.e. when the respective springs are compressed in case they are driven by a rod and spring unit as illustrated herein for example, they are kept distant from the slides thereby allowing unrestricted positioning of the bottom slide TS on the foam 18 or the top slide AS on the pins 52, 53, 55 and 62 (see FIGS. 4 and 6).

The two slides are positioned within the device 10 using the common reference pins, i.e. the fixed reference position pins 54, 56, 58, thereby ensuring their relative alignment, i.e. alignment of cognate spots thereof in the device 10. Using common reference pins eliminates the effect of any geometrical variation in the device due to the fabrication process in contrast to non-common reference pins, as the distance between non-common reference pins or their relative positions may be directly affected by fabrication tolerances. The number of common reference pins for positioning the slides is at least two. More may be used, even so as to form a common abutment wall for example, i.e. a common reference wall.

As all pins protrude from the same part of the device, i.e. from the shell 12 in the embodiment shown herein, there is no interference between the pins and the slides when closing the device 10 by bringing the top shell 14 over the shell 12.

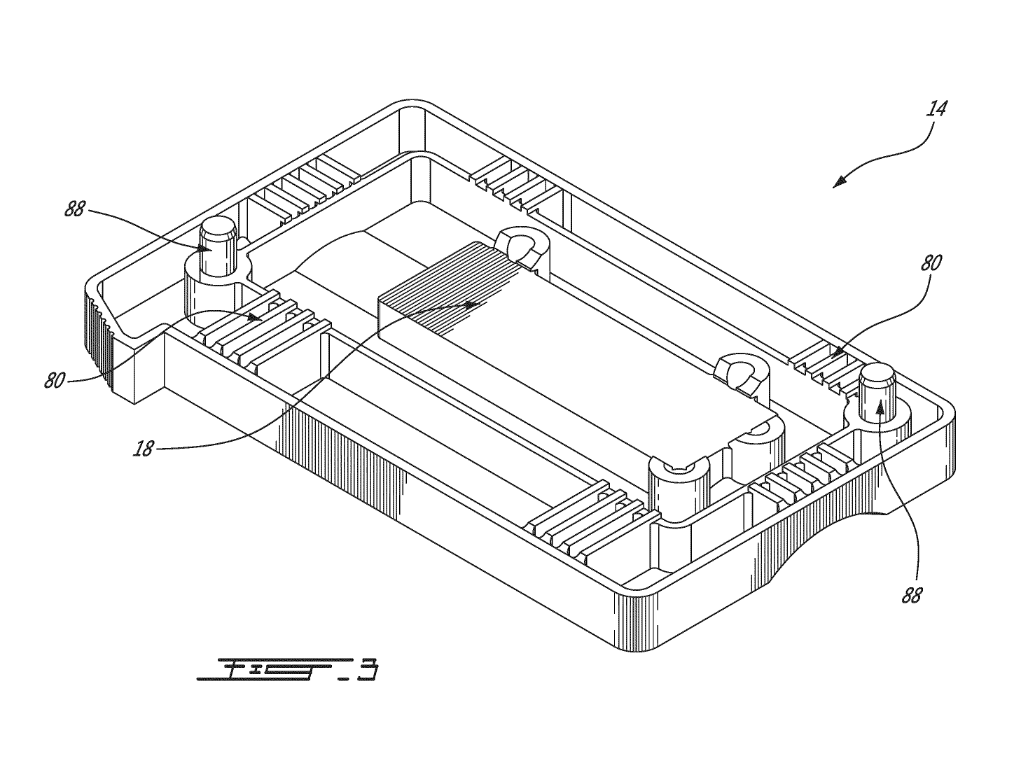

A foam 18, of a thickness of 1/16″ compressed over 0.015′ for example, on the inner surface of the top shell 14 (see FIG. 3) allows evenly distributing the pressure submitted on slides positioned on the base shell 12 when the top shell 14 and the base shell 12 are assembled together in the closed position of the device, as will be described hereinbelow. When the shell 12 and the shell 14 are brought together for the microarray-to-microarray transfer, a force applied between the shell 12 and the shell 14 compresses the pogopins and puts the slides into contact. The force applied should be large enough to also compress the foam (not shown) that sits on the top surface of the bottom shell underneath the slide. The top shell 14 (or the bottom shell) may comprise surfaces stoppers 80 of a height selected so that upon closing of the device, the stoppers 80 do not contact an opposite surface on the inner surface of the bottom shell until the foams have reached a predetermined compressed state, thereby controlling the relative displacement of the slides and compression of the foams, i.e. the foam (not shown) that sits on the top surface of the bottom shell underneath the slide and the foam 18 in such a way that beyond a determined threshold, any additional or variation in the force applied does not have any effect on the force submitted to the slides themselves.

Such configuration of stoppers and foams allows controlling the pressure submitted to the slides during assembly thereof and controlling the gap between the two slides so as to avoid excessive pressure between the slides during closing of the device, and then maintaining a uniform pressure all over their surface, as none of the slides is directly supported by the inner surfaces of the device. The thickness and rigidity of the foams may be selected depending on the thickness of the slides.

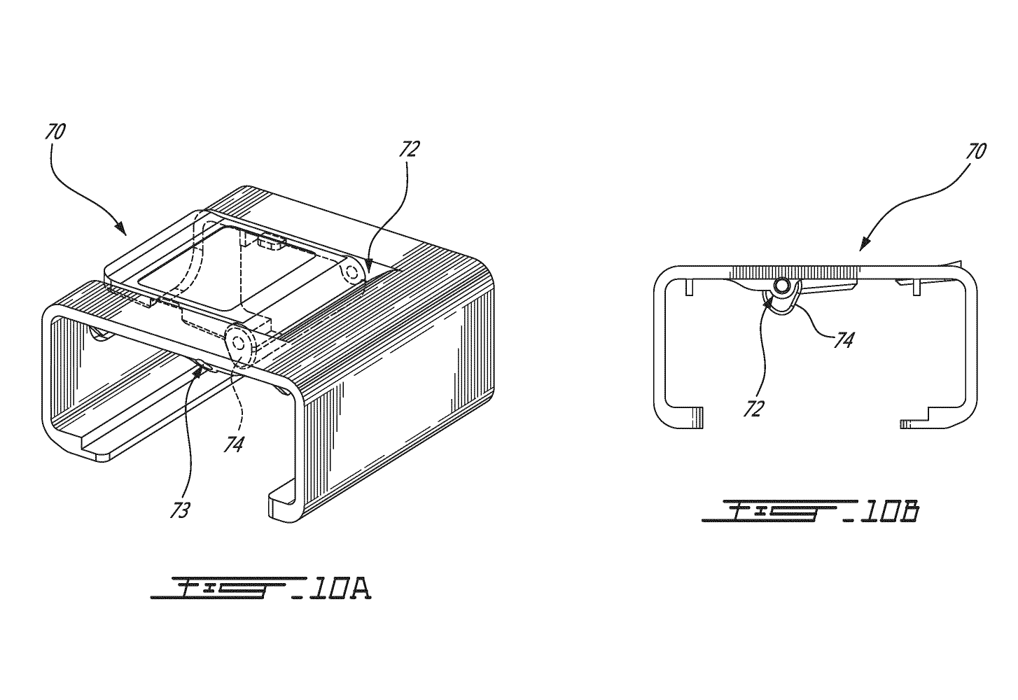

A C-clamp 70 may be used to hold the shell 12 and top shell 14 together when the slides are positioned (see FIG. 10), in such a way that a same force is applied thereon each time. A force tab 71 is pivotally assembled to the body of the C-Clamp using pins (not shown) by an edge 75 thereof in fixing holes 72, 73. The edge 75 is excentric, so when the tab 71 is vertical, there is no pressure applied on the device 10, whereas a protuberance 74 of the edge 75 applies pressure on the device within the clamp 70 when the tab 71 is horizontal as shown for example in FIG. 10D. The C-Clamp 70 thus ensures the application of the same force on the device each time it is used. The size of the protuberance 74 determines the force applied on the device 10, and it has been adjusted to result in a force above the threshold discussed hereinabove.

The shell 12 comprises receiving apertures 81 (see FIG. 4) and the top shell 14 comprises corresponding rods 88 (see FIG. 3), the rod 88 engaging the receiving apertures 81 when the top shell 14 and the base shell 12 are assembled together in the closed position of the device, thereby ensuring the alignment of the shell 12 and top shell 14, as well as maintaining the shell 12 and shell 14 parallel as they are brought together. The tolerance on this alignment is low and does not affect the alignment of the slides.

Opposite magnets may be provided on each one of the top shell 14 and the base shell 12 (not shown) to further secure and stabilize the top shell 14 and the base shell 12 together, if needed, when positioning the clamp 70 for example.

FIG. 11A shows a bottom slide 100 according to an embodiment of an aspect of the present invention. The bottom slide 100 is of a rectangular shape, with a clipped corner 110, which allows that the fixed pogopin 62 reaches the top slide as discussed hereinabove (see FIG. 7). The thickness T of the slide 100 is selected, for example of 1.5 mm, so as to provide a sufficient lateral surface for the bodies 59 of the pogopins 52, 53, 55 to abut against the edge of the bottom slide and maintain a pressure on the bottom slide while ensuring that the top slide does not rest on the body 59 of the pogopins 52, 53, 55 but is only supported by their tips 61.

The slides may be in glass, plastic or silicon for example.

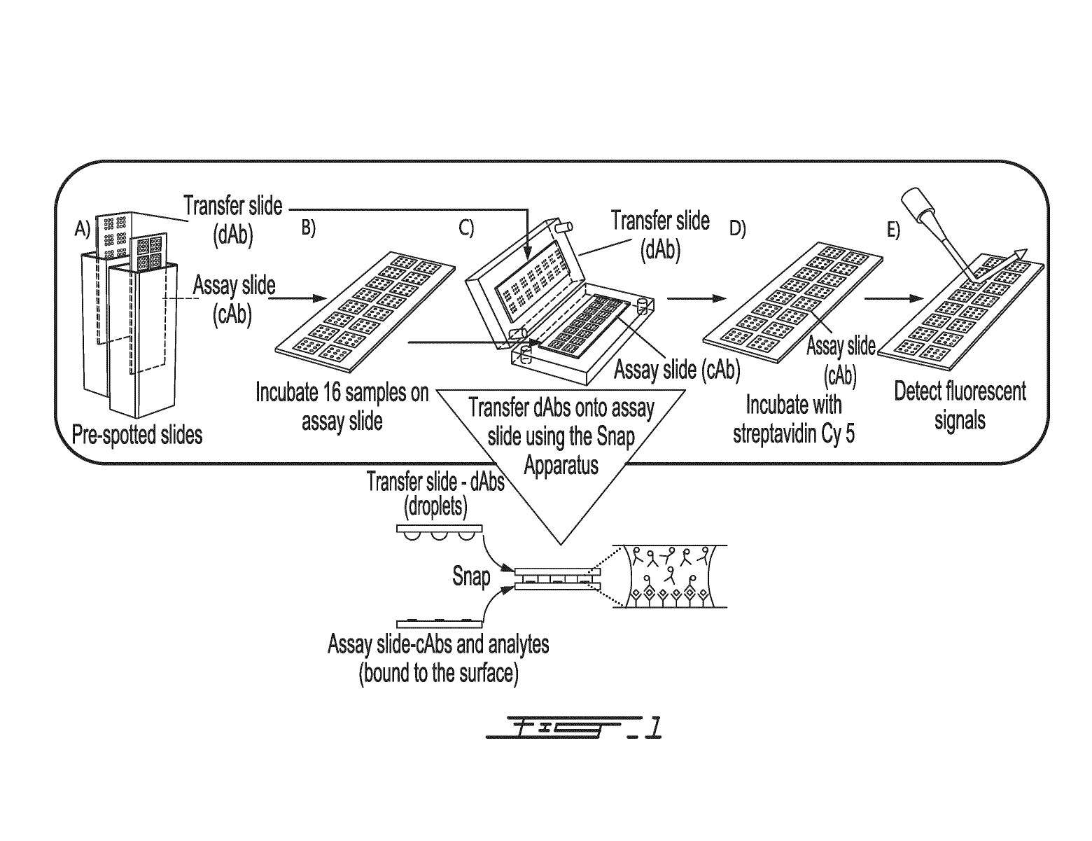

A sheet of absorbing paper 120 supported by a slide 100′, as shown for example in FIG. 11B, may be used so as to absorb droplets on the top slide AS before a washing step (see FIG. 1, between steps C and D). Alternatively, vacuum may be used instead of an absorbing paper to suck any droplets between spots of the slide. Still alternatively, micro-wells may be used as spot receptacles on the slide in order to limit the spreading of the droplets and prevent cross-contamination between the spots on the slide AS.

According to an embodiment of an aspect of the present invention, an assay comprises: i) setting the movable pins 60, 64, 66 and 52, 53, 55 in the rest position (see for example FIG. 6); ii) inserting the bottom slide TS in the shell 12; iii) setting the movable pogopins 52, 53 and 55 in the working position, thereby aligning the bottom slide against the reference pins 54, 56, 58; iv) inserting the top slide AS in the shell 12 sitting on the pogopins 52, 53, 55 and 62; v) setting the movable pins 60, 64 and 66 in the working position, thereby aligning the bottom slide and the top slide against the reference position pins 54, 56, 58; vi) assembling the top shell 14 on top of the bottom shell 12; vii) lifting the force tab 71 and inserting the device 10 into the clamp 70; viii) pushing down the force tab 71 and waiting for 30 sec; ix) opening the device, removing the top slide AS and continuing with the protocol as shown in FIG. 1 and discarding the bottom slide TS.

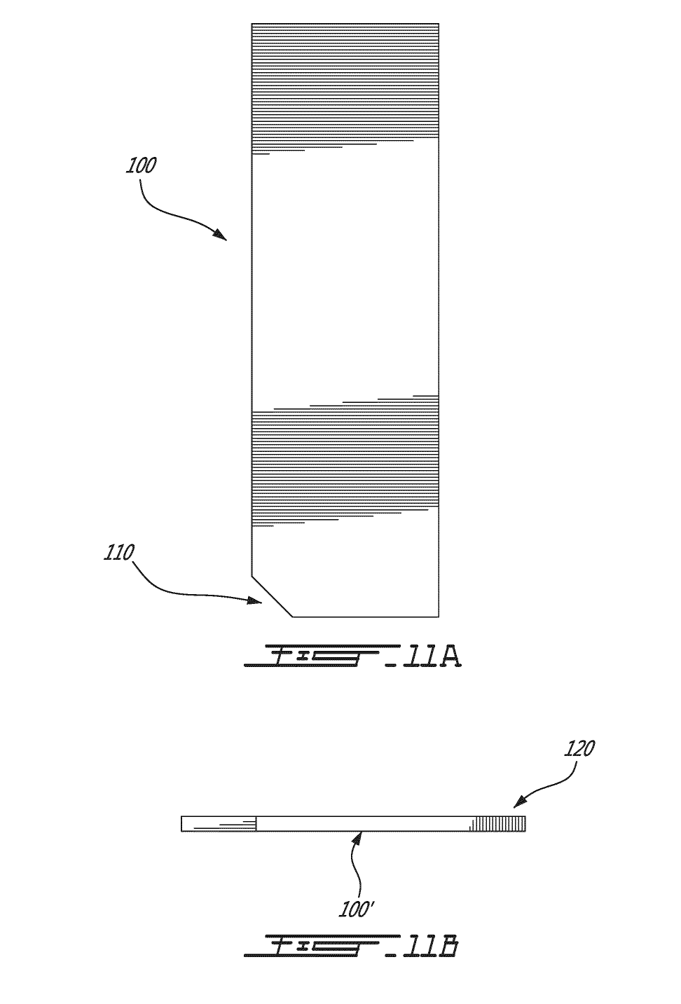

Droplets are deposited on the slides to form the spots before positioning the slides in the device as described hereinabove. For laying droplets on the slides using a microarrayer as known in the art, the slides may be positioned using a deck 130 as shown in FIG. 12 for example. Reference pins 131, 132, 133/134 are positioned on the deck in correspondence with the reference pins 54, 56, 58 of the device. They are used as references to position the slides side by side on the deck and abut the slides at the same relative position as reference pins 54, 56, 58 to eliminate any effect of imperfection or irregular slides edges. Spring-loaded blocks 135, or alternatively a magnetic system for example, can be used to push the slides against the reference pins 131, 132, 133/134 of the deck. In FIG. 12, the slide AS is thus positioned on the deck using its right edge while the slide TS is positioned on the deck using its left edge (as accomplished in the shell 12 considering the slide AS is flipped once positioned in the device 10). The reference pins 131, 132, 133/134 for example, or other references, are then recognized by the camera of the microarrayer and used as fiducials markers to reproducibly deposit droplets at precise positions on the slides.

The dimensions of the bottom slide, as well as its thickness and/or the geometry of its edges, can vary, provided they allow insertion of the pogopins 52, 53, 55 and 62 for support of the top slide so as to maintain the top slide above the bottom slide. Alternatively, these pogopins may go through holes or apertures provided in the bottom slide, so as to reach and contact the under surface of the top slide.

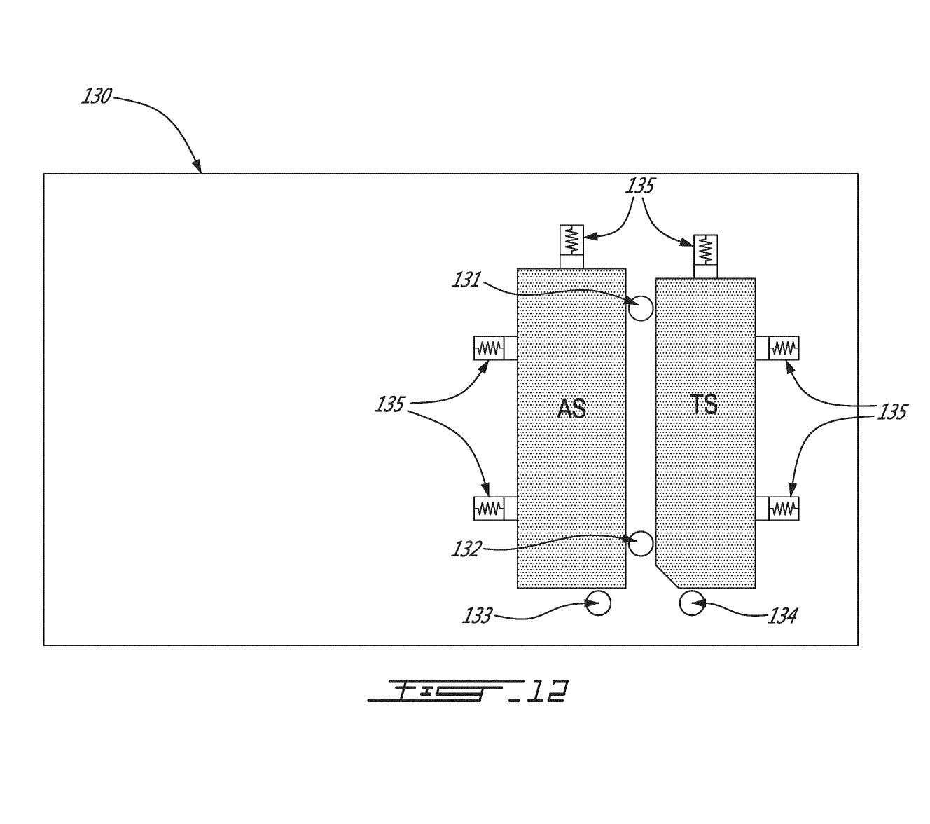

Alternatively, one of the slides could be positioned on the top shell 14 with a male positioning pin 54a and the other one of the slides could be positioned on the base shell 12 with a female pin 54b shown in FIG. 13 for example, the male positioning pin 54a engaging the female positioning pin 54b upon closure of the device by bringing the top shell 14 over the base shell 12, thereby forming a common positioning pin.

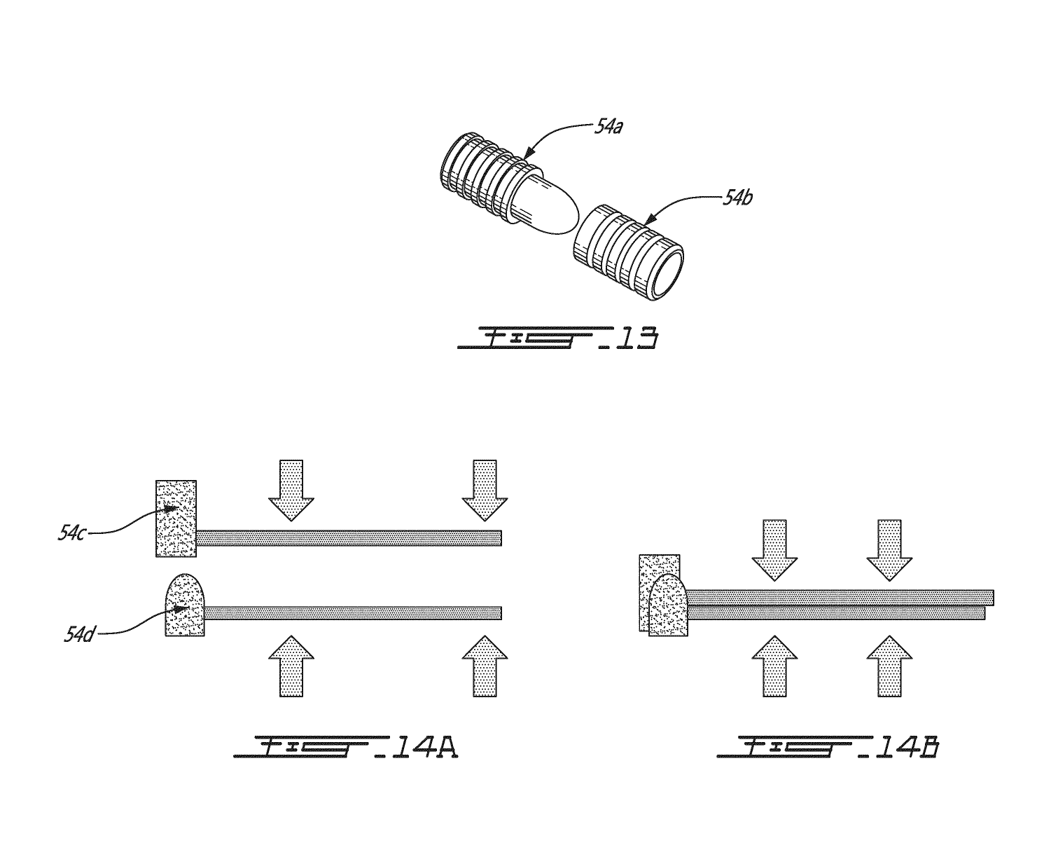

Still alternatively, still in the case of each one of the top shell 14 and the base shell 12 supporting one slide each, a positioning pin 54c could be used for the slide on the top shell 14, and another positioning pin 54D used for the slide of the base shell 12. By selecting a rounded shape of the positioning pin 54D as shown for example in FIG. 14, when the top shell 14 is brought together with the base shell 12, the top slide may be made to slide against the curved surface of the positioning pin 54D, thereby forming a common positioning pin and aligning the top and bottom slides (see FIG. 14B).

The scope of the claims should not be limited by the illustrative embodiments set forth in the examples, but should be given the broadest interpretation consistent with the description as a whole.

1. A microarray-to-microarray transfer device, comprising:
a first shell having an inner surface configured to receive a bottom slide and a top slide; and
a second shell configured to be assembled on top of said first shell with an inner surface thereof facing the inner surface of said first shell in a closed position of the device;
wherein the inner surface of the first shell comprises position pins, first movable pins and second movable pins, said first and second movable pins being movable from a resting position allowing insertion of the bottom slide to a working position, said first movable pins, in a working position thereof, pushing the bottom slide against said reference pins and maintaining a desired distance between the bottom slide and the top slide until the device is closed, and said second movable pins, in a working position thereof, maintaining the bottom slide and the top slide aligned against said position pins, said position pins forming common reference pins for the bottom slide and the top slide.

2. The device of claim 1, wherein the inner surface of the first shell comprises at least two reference position pins.

3. The device of claim 1, wherein the inner surface of the first shell further comprises a foam, said foam supporting said bottom slide.

4. The device of claim 1, wherein the inner surface of the first shell further comprises a foam, said foam supporting said bottom slide, the inner surface of the second shell comprising at least one stopper of a thickness selected to control a relative displacement of the slides and compression of said foam in the closed position of the device.

5. The device of claim 1, wherein the inner surface of the second shell further comprises a foam.

6. The device of claim 1, wherein the inner surface of the first shell further comprises a first foam, said first foam supporting said bottom slide, the inner surface of the second shell further comprises a second foam, at least one of: i) the inner surface of the first shell and ii) the inner surface of the second shell further comprising at least one stopper of a thickness selected to control a relative displacement of the slides and compression of said foams in the closed position of the device.

7. The device of claim 1, wherein each movable pin is driven by a rod and spring unit.

8. The device of claim 1, wherein said movable pins comprise at least one movable pin having a tip pin coming into abutment against an edge of the top slide in the working position thereof, and at least one movable pin having a body pushing the bottom slide against the reference pins, and a compressible top maintaining a desired distance between the bottom slide and the top slide until the device is closed and a pressure is applied to bring the two slides together in the closed position of the device.

9. The device of claim 1, wherein said movable pins comprise at least one first movable pin having a tip pin coming into abutment against an edge of the top slide in the working position thereof, and at least one second movable pin having a body pushing the bottom slide against the reference pins, and a compressible top section maintaining a desired distance between the bottom slide and the top slide until the device is closed and a pressure is applied to bring the two slides together, said bottom slide comprising one of: i) a clipped corner and ii) an opening at a position of said second movable pin.

10. The device of claim 1, further comprising a C-clamp to hold the first and second shells together in the closed position of the device.

11. The device of claim 1, further comprising a C-clamp to hold the first and second shells together in the closed position of the device, said C-clamp comprising a force tab pivotally assembled to the body of the C-Clamp by an eccentric edge thereof, wherein, when said tab is in a first position, there is no pressure applied on the device, whereas a protuberance of the edge applies pressure on the device within the clamp when the tab is in a second position, said C-Clamp thus ensuring application of a constant force on the device in the second position.

12. A method of microarray-to-microarray transfer, comprising:
providing a first shell comprising position pins and first and second movable pins on an inner surface thereof;
setting the first and second movable pins in a rest position and inserting a first slide on the inner surface of the first shell;
setting the first movable movable pins in a working position, thereby aligning the first slide against the position pins;
depositing a second slide on top of the first movable pins; and
setting the second movable movable pins in a working position, thereby aligning the first and second slides against the position pins as common reference position pins; and
assembling a second shell on top of the first shell.

13. The method of claim 12, wherein said assembling the top shell on top of said first shell comprises using a C-clamp.

14. The method of claim 12, wherein said inserting the first slide on the inner surface of the first shell comprises depositing the first slide on a foam on the inner surface of the first shell.

15. A method of microarray-to-microarray transfer, comprising inserting a first slide on an inner surface of a first shell and aligning the first slide against reference pins of the inner surface of the first shell using first movable pins of the inner surface of the first shell; inserting a second slide on a top tips of the first movable pins; aligning the first and second slides against the reference pins using second movable pins of the inner surface of the first shell; and assembling a second shell on top of the first shell.
